(19) United States
(12) Patent Application Publication
(10) Pub. No.: US 2007/0233490 A1
(43) Pub. Date: Oct. 4, 2007

(54) SYSTEM AND METHOD FOR TEXT-TO-PHONEME MAPPING WITH PRIOR KNOWLEDGE

(75) Inventor: Kaisheng N. Yao, Dallas, TX (US)

Correspondence Address: TEXAS INSTRUMENTS INCORPORATED, P O BOX 655474, M/S 3999, DALLAS, TX, 75265, US

(73) Assignee: Texas Instruments, Incorporated, Dallas, TX (US)

(21) Appl. No.: 11/278,497

(22) Filed: Apr. 3, 2006

(51) Int. Cl. G10L 13/08

(52) U.S. Cl. 704/260

(57) ABSTRACT

A system for, and method of, text-to-phoneme (TTP) mapping and a digital signal processor (DSP) incorporating the system or the method. In one embodiment, the system includes: (1) a letter-to-phoneme (LTP) mapping generator configured to generate an LTP mapping by iteratively aligning a full training set with a set of correctly aligned entries based on statistics of phonemes and letters from the set of correctly aligned entries and redefining the full training set as a union of the set of correctly aligned entries and a set of incorrectly aligned entries created during the aligning and (2) a model trainer configured to update prior probabilities of LTP mappings generated by the LTP generator and evaluate whether the LTP mappings are suitable for training a decision-tree-based pronunciation model (DTPM).

### CROSS-REFERENCE TO RELATED APPLICATION

The present invention is related to U.S. patent application Ser. No. 11/195,895 by Yao, entitled “System and Method for Noisy Automatic Speech Recognition Employing Joint Compensation of Additive and Convolutive Distortions,” filed Aug. 3, 2005, U.S. patent application Ser. No. 11/196,601 by Yao, entitled “System and Method for Creating Generalized Tied-Mixture Hidden Markov Models for Automatic Speech Recognition,” filed Aug. 3, 2005, and U.S. patent application Ser. No. [Attorney Docket No. TI-60051] by Yao, entitled “System and Method for Combined State- and Phone-Level Pronunciation Adaptation for Speaker-Independent Name Dialing,” filed ______, all commonly assigned with the present invention and incorporated herein by reference.

### TECHNICAL FIELD OF THE INVENTION

The present invention is directed, in general, to automatic speech recognition (ASR) and, more particularly, to a system and method for text-to-phoneme (TTP) mapping with prior knowledge.

### BACKGROUND OF THE INVENTION

Speaker-independent name dialing (SIND) is an important application of ASR to mobile telecommunication devices. SIND enables a user to contact a person by simply saying that person's name; no previous enrollment or pre-training of the person's name is required.

Several challenges, such as robustness to environmental distortions and pronunciation variations, stand in the way of extending SIND to a variety of applications. However, providing SIND in mobile telecommunication devices is particularly difficult, because such devices have quite limited computing resources.

SIND requires a list of names (which may amount to thousands) to be recognized, therefore techniques that generate phoneme sequences of names are necessary. However, because of the above-mentioned limited resources, a large dictionary with many entries cannot be used. It is therefore important to have methods that are compact and accurate to generate phoneme sequences of name pronunciations in real time. These methods are usually called “text-to-phoneme” (TTP) mapping algorithms.

Conventional TTP mapping algorithms fall into two general categories. One category is algorithms based on phonological rules. The phonological rules are used to map a word to corresponding phone sequences. A rule-based approach usually works well for some languages with “regular” mappings between words and pronunciations, such as Chinese, Japanese or German. In this context, “regular” means that the same grapheme always corresponds to the same phoneme. However, for some other languages, notably English, a rule-based approach may not perform well due to “irregular” mappings between words and pronunciations.

Another category is data-driven approaches, which have come about more recently than rule-based approaches. These approaches include neural networks (see, e.g., Deshmukh, et al., “An advanced system to generate pronunciations of proper nouns,” in ICASSP, 1997, pp. 1467-1470), decision trees (see, e.g., Suontausta, et al., “Low memory decision tree method for text-to-phoneme mapping,” in ASRU, 2003) and N-grams (see, e.g., Maison, et al., “Pronunciation modeling for names of foreign origin,” in ASRU, 2003, pp. 429-34).

Among these data-driven approaches, decision trees are usually more accurate. However, they require relatively large amounts of memory. In order to reduce the size of decision trees so they can be used in mobile telecommunication devices, techniques for removing “irregular” entries from training dictionaries, such as post-processing (see, e.g., Suontausta, et al., supra], have been suggested. These techniques, however, require much manual intervention to work.

Accordingly, what is needed in the art is a new technique for TTP mapping that is not only relatively fast and accurate, but also more suitable for use in mobile telecommunication devices than are the above-described techniques.

### SUMMARY OF THE INVENTION

To address the above-discussed deficiencies of the prior art, the present invention provides techniques for TTP mapping and systems and methods based thereon.

The foregoing has outlined features of the present invention so that those skilled in the pertinent art may better understand the detailed description of the invention that follows. Additional features of the invention will be described hereinafter that form the subject of the claims of the invention. Those skilled in the pertinent art should appreciate that they can readily use the disclosed conception and specific embodiment as a basis for designing or modifying other structures for carrying out the same purposes of the present invention. Those skilled in the pertinent art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawing, in which:

FIG. 1 illustrates a high level schematic diagram of a wireless telecommunication infrastructure containing a plurality of mobile telecommunication devices within which the system and method of the present invention can operate;

FIG. 2 illustrates a high-level block diagram of a DSP located within at least one of the mobile telecommunication devices of FIG. 1 and containing one embodiment of a system for TTP mapping with prior knowledge constructed according to the principles of the present invention;

FIG. 3 illustrates a flow diagram of one embodiment of a method of TTP mapping with prior knowledge carried out according to the principles of the present invention;

FIG. 4 illustrates a graphical representation of one example of an estimated posterior probability of a phoneme p given a letter l and wherein the number of inner-loop iterations, n, equals 1;

FIG. 5 illustrates a graphical representation of one example of an estimated posterior probability of a phoneme p given a letter l and wherein the number of inner-loop iterations, n, equals 5;

FIG. 6 illustrates a graphical representation of one example of a performance of an un-pruned DTPM as a function of memory size;

FIG. 7 illustrates a graphical representation of one example of a performance of a pruned DTPM as a function of memory size; and

FIG. 8 illustrates a graphical representation of one example of a performance of the pruned DTPM of FIG. 6 as a function of a pruning threshold, θ_{A}.

### DETAILED DESCRIPTION

Described herein are particular embodiments of a novel TTP mapping technique. The technique systematically regularizes dictionaries for training DTPMs for name recognition. In general, the technique is based upon an Expectation-Maximization (E-M)-like iterative algorithm to obtain probabilities of a particular letter given a particular phoneme. That is, the technique iteratively updates estimates of probabilities of a particular phoneme given a particular letter. In one embodiment, a prior knowledge of LTP mapping is incorporated via prior probabilities of a particular phoneme given a particular letter to yield an improved TTP performance. In one embodiment, the technique updates posterior probabilities of a particular phoneme given a particular letter by Bayesian updating. In order to remove unreliable LTP mappings and to regularize dictionaries, a threshold may be set and, by comparison with the threshold, LTP mappings having lower posterior probabilities may be removed. As a result, the technique does not require much human effort in developing a small DTPM for SIND. As will be described below, exemplary DTPMs were obtained having a memory size smaller than 250 Kbytes.

Certain embodiments of the technique of the present invention have two advantages over conventional techniques for TTP mapping. First, the technique of the present invention makes better use of prior knowledge to TTP performance. This is in contrast to certain prior art methods (e.g., Damper, et al., “Aligning letters and phonemes for speech synthesis,” in ISCA Speech Synthesis Workshop, 2004) that make no use of prior knowledge. Such methods may have a relatively high LTP alignment rate, but they fail to remove some entries, such as foreign pronunciations, that are useless for name recognition in a particular language. Second, the technique of the present invention employs a threshold to regularize the dictionary. The threshold tends to diminish prior probabilities automatically over time. Thus, the substantial human effort that would otherwise be required manually to dispense with entries having lower posterior probabilities is no longer required. This is in stark contrast with post-processing methods taught, e.g., in Suontausta, et al., supra. Post-processing methods use human LTP-mapping knowledge to remove low probability entries in a hard-decision way and are therefore tedious and prone to human error.

Having described the technique in general, a wireless telecommunication infrastructure in which the TTP technique of the present invention may be applied will now be described. Then, one embodiment of the TTP technique, including some important implementation issues, will be described. A DTPM based on the TTP technique will next be described. Finally, the performance of an exemplary embodiment of the TTP technique of the present invention will be evaluated in the context of SIND in a mobile telecommunication device.

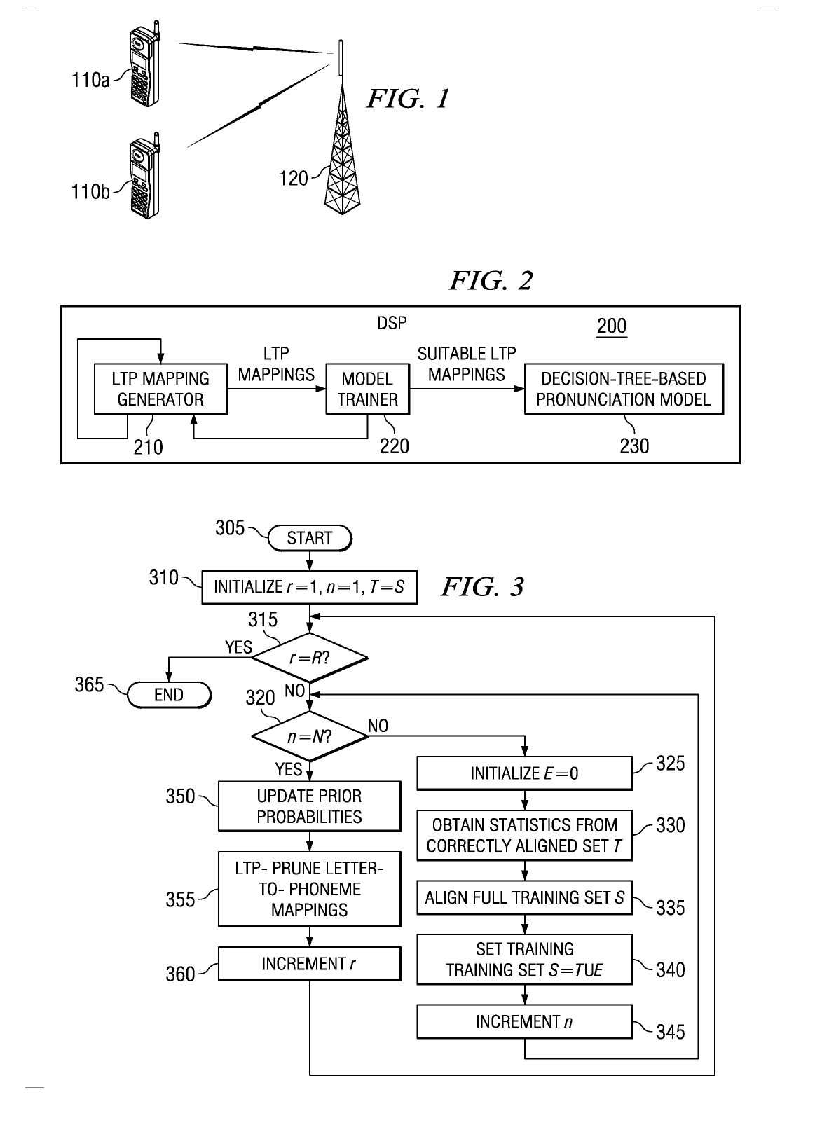

Accordingly, referring to FIG. 1, illustrated is a high level schematic diagram of a wireless telecommunication infrastructure, represented by a cellular tower 120, containing a plurality of mobile telecommunication devices 110a, 110b within which the system and method of the present invention can operate.

One advantageous application for the system or method of the present invention is in conjunction with the mobile telecommunication devices 110a, 110b. Although not shown in FIG. 1, today's mobile telecommunication devices 110a, 110b contain limited computing resources, typically a DSP, some volatile and nonvolatile memory, a display for displaying data, a keypad for entering data, a microphone for speaking and a speaker for listening. Certain embodiments of the present invention described herein are particularly suitable for operation in the DSP. The DSP may be a commercially available DSP from Texas Instruments of Dallas, Tex.

Having described an exemplary environment within which the system or the method of the present invention may be employed, various specific embodiments of the system and method will now be set forth.

The TTP mapping problem may reasonably be viewed as a statistical inference problem. The probability of a phoneme p given a letter l is defined as P(p|l). Given a word entry with an L-length sequence of letters (l₁, . . .l_{L}), a TTP mapping may be carried out by the following Maximum a Posteriori (MAP) probability method:

$$( {p}_{1}^{*} , … , {p}_{L}^{*} ) = arg {max}_{{p}_{1} , … , {p}_{L}} P ( ( {p}_{1} , … , {p}_{L} ) \vert ( {l}_{1} , … , {l}_{L} ) ) P ( {l}_{1} , … , {l}_{L} ) , \qquad ( 1 )$$

where P((p₁, . . . , p_{L})|(l₁, . . . , l_{L})) is the probability of a phoneme sequence (p₁, . . . , p_{L}) given a letter sequence (l₁, . . . , l_{L}). If it is assumed that the phoneme pᵢ is dependent only on the current letter lᵢ, the probability may be simplified as:

$$P ( ( {p}_{1} , … , {p}_{L} ) \vert ( {l}_{1} , … , {l}_{L} ) ) = {\prod }_{i = 1}^{L} P ( {p}_{i} \vert {l}_{i} ) . \qquad ( 2 )$$

A good estimate of the above probability is required to have good TTP mapping. However, some difficulties arise in achieving good TTP mapping in irregular languages, such as English. For example, English exhibits LTP mapping irregularities. A reasonable alignment between the proper name “Phil” and its pronunciation “f ih l” may be:

| | | | |
|---|---|---|---|
| P | h | i | l |
| f | _{—} | ih | l |

In English, it is common for a word to have fewer phonemes than letters. Accordingly, a “null” (or “epsilon”) phone “_” should be inserted in the transcription to maintain a one-to-one mapping. Yet, in “Phil,” it is not clear where the null-phone should be placed, since the following may also be a reasonable alignment:

| | | | |
|---|---|---|---|
| P | h | i | l |
| f | ih | _{—} | l |

Cases also occur in which one letter corresponds to two phonemes. For instance, the letter “x” is pronounced as “k s” in word “fox.” “Pseudo-phonemes” are obtained by concatenating two phonemes that are known to correspond to a single letter. In this case, “k_s,” which is a concatenation of the two phonemes, “k” and “s,” is the pseudo-phoneme of the letter “x.”

English also contains entries from other languages. For example, the word “Jolla” is pronounced as “hh ow y ah.” The word is common in American English, although it is from Spanish. However, such entries increases the “irregularity” of training dictionary for English name recognition.

Training dictionaries may further contain incorrect entries, such as typographical errors. These incorrect entries increase the overall irregularity of the training dictionary.

Incorporating prior human knowledge into TTP mapping may be helpful to obtain a good estimate of the above probability. Here, the prior knowledge is incorporated by setting prior probabilities P*(p|l) to zero, corresponding to removal of non-zero LTP mappings between l and p and allowing l to be pronounced as p. For instance, setting P*(p|l)=0, where p is “hh” and l is “j,” removes some entries such as “Jolla.”

Having described the nature of the TTP mapping problem in general, one specific embodiment of the system of the present invention will now be presented in detail. Accordingly, turning now to FIG. 2, illustrated is a high-level block diagram of a DSP 200 located within at least one of the mobile telecommunication devices of FIG. 1 and containing one embodiment of a system for TTP mapping with prior knowledge constructed according to the principles of the present invention.

The system includes an LTP mapping generator 210. The LTP mapping generator 210 is configured to generate an LTP mapping by iteratively aligning a full training set (e.g., S) with a set of correctly aligned entries (e.g., T) based on statistics of phonemes and letters from the set of correctly aligned entries and redefining the full training set as a union of the set of correctly aligned entries and a set of incorrectly aligned entries (e.g., E) created during the aligning. In the illustrated embodiment, the LTP mapping generator 210 is configured to generate the LTP mapping over a predetermined number (e.g., n) of iterations, represented by the circular line wrapping around the LTP mapping generator 210.

The system further includes a model trainer 220. The model trainer 220 is configured to update prior probabilities of LTP mappings generated by the LTP generator 210 and evaluate whether the LTP mappings are suitable for training a DTPM 230. In the illustrated embodiment, and the model trainer 220 is configured to evaluate a predetermined number (e.g., r) of LTP mappings generated by the LTP generator 210, represented by the curved line leading back from the model trainer 220 to the LTP mapping generator 210.

The operation of certain embodiments of the LTP mapping generator 210 and the model trainer 220 will now be described. Accordingly, turning now to FIG. 3, illustrated is a flow diagram of one embodiment of a method of TTP mapping with prior knowledge carried out according to the principles of the present invention.

The technique of FIG. 3 is an iterative TTP technique. A prior knowledge of allowed LTP mappings is incorporated into a TTP process via prior probabilities of a particular phoneme given a particular letter. A Bayesian updating refines the posterior probabilities of a particular phoneme given a particular letter.

A full training set S is first defined. S consists of two sets T and E, where T is a set of correctly aligned entries, and E is a set of incorrectly aligned entries. The method begins in a start step 305. The method is iterative and has outer and inner loops, viz:
1. Initialize iteration numbers: r=1 and n=1 (a step 310).
2. Initialize set T to S (also the step 310).
3. Iterate an outer loop r=R (a decisional step 315).
(a) Iterate an inner loop until n=N (decisional step 320).
i. Initialize set E to Ø (step 325).
ii. Obtain the statistics of phonemes and letters from set T (step 330).
Calculate the probability of phoneme p given letter l:

$$P ( p \vert l ) = \frac{C ( l , p )}{C ( l )} \qquad ( 3 )$$
where C(l,p) is the number of co-occurrences of phoneme p and letter l. C(l)=ΣₚC(l, p).
Calculate the probability of letter l given phoneme p:

$$P ( l \vert p ) = \frac{C ( l , p )}{C ( p )} \qquad ( 4 )$$
Update the posterior probability of phoneme p given letter l:

$$\tilde{P} ( p \vert l ) = \frac{P ( l \vert p ) {P}^{*} ( p \vert l )}{P ( l )} \qquad ( 5 )$$
where P(l)=ΣₚP(l|p)P*(p|l) and P*(p|l) is the prior probability of phoneme p and letter l. (Initialization of the prior probability will be described below.)
iii. Align the full training set S (step 335).
A. For every entry wεS, do TTP alignment to obtain the phoneme sequence with the maximum a posteriori probability, i.e.:

$$( {p}_{1}^{*} , … , {p}_{L}^{*} ) = arg {max}_{{p}_{1} , … , {p}_{L}} {\prod }_{i = 1}^{L} \tilde{P} ( {p}_{i} \vert {l}_{i} ) p ( {l}_{i} ) \qquad ( 6 )$$
where L is the length of the name. Since lᵢ is given during alignment, p(lᵢ)=1.
B. Check if every pair (lᵢ, pᵢ) in the aligned entry is allowed. For numerical reasons, (for example, a flooring mechanism applied to \tilde{P}(p|l)), the alignment process of Equation (6) may yield some letter-phoneme pairs (lᵢ, pᵢ) that are not allowed. Checking may be done by determining if pᵢ is in the allowed list of phonemes for letter lᵢ. The allowed list of phonemes is also used for flat initialization of the prior probability P*(p|l) further described below.
   If yes, provide the TTP mapping to set T.
   If no, remove epsilon phones from the aligned pronunciation and then save the pronunciation together with the word to E. In the next inner-loop iteration, entries in E may be correctly aligned because of the improved estimate of \tilde{P}(p|l).
iv. Set training set S=T∪E (step 340). Increment n (step 345), and go back to step 3(a)ii (the step 320).
(b) Update prior probabilities of phoneme p given letter l (step 350) by the updated a posteriori probability:
   \tilde{P}*(p|l)=\tilde{P}(p|l), (7)
(c) LTP-prune LTP mappings (step 355). For each entry in S, test if all LTP mappings have higher posterior probability P(pᵢ|lᵢ) than a threshold θ_{A}; i.e., if \tilde{P}(pᵢ|lᵢ)≧θ_{A}, ∀ᵢε{1, . . . , L}.
   If yes, provide the TTP mapping to train the DTPM.
   If no, discard the TTP mapping; do not use it to train the DTPM.
(d) Increment r (step 360) and go back to step 3 (the step 315). The method ends in an end step 365.

As described above, the method is based upon an E-M-like iterative algorithm. Step 3(a)ii corresponds to the E-step in the E-M algorithm. Step 3(a)iii is the M-step in the E-M algorithm. The normal E-M algorithm may use the estimated posterior probability P(p|l) obtained in Equation (3) in place of \tilde{P}(p|l) in Equation (6) for the M-step to have TTP alignment.

As previously described prior knowledge of LTP mapping is incorporated into the method; this yields an improved posterior probability \tilde{P}(p|l). By Equation (5), the improved posterior probability is obtained in consideration of both observed LTP pairs and the prior probability of LTP mapping P*(p|l).

The following gives an example of the motivation for using Equation (5). Only three training cases exist for the phoneme “y_ih,” which include “POIGNANCY:” “p oy_{——}n y_ih n s iy.” Hence, C(A,y_ih)=3, P(A|y_ih)=C (A,y_ih)/C(y_ih)=1.0, and P(y_ih|A)=C(A,y_ih)/C(A)=3/C(A) approaches zero. But if LTP-pruning is used, P(y_ih|A) will be removed if it is below threshold θ_{A}. Consequently, three cases that could otherwise be used to train DTPM are lost. In contrast to the normal E-M algorithm, the following results:
P(y_{—}ih|A)=P(A|y_{—}ih)Q(y_{—}ih|A)/P(A)=Q(y_{—}ih|A)/P(A),
which is usually larger than that by the normal E-M estimate, if Q(y_ih|A) has a large value of the prior probability of phoneme y_ih given letter A.

One implementation issue regarding the method involves the initialization of the prior probability P*(p|l). A flat initialization is done on the prior probability P*(p|l). Given lists of allowed phonemes for each letter l, the prior probability of each phoneme given the letter is set to 1/#p, where #p denotes the number of possible phonemes for the letter l.

Another implementation issue regarding the method involves the initialization of co-occurrence matrices. The above iterative algorithm converges to a local optimal estimate of posterior probabilities of a particular phoneme given a particular letter. One possible initialization method may use a naive approach, e.g., Damper, et al., supra. Processing each word of the dictionary in turn, every time a letter l and a phoneme p appear in the same word irrespective of relative position, the corresponding co-occurrence C(l, p) is incremented. Although this would not be expected to give a very good estimate of co-occurrence, it is sufficient to attempt an initial alignment.

Yet another implementation issue regarding the method involves the flooring of LTP mappings to the epsilon phone. It may fairly be assumed that every letter may be pronounced as an epsilon phone. Therefore, the LTP-pruning may prune LTP mappings with low posterior probabilities, except for LTP mappings to the epsilon phone. In addition, a flooring mechanism is set to provide a minimum posterior probability of LTP mappings to the epsilon phone. In one embodiment of the present invention, the flooring value is set to a very small value above zero.

Still another implementation issue regarding the method involves the position-dependent rearrangement. Using the above process, DTPMs may result that generate pronunciations such as:

AARON aa ae r ax n

which has an insertion of “ae” at the second letter “A.” After analyzing the aligned dictionary by the above alignment process, the following typical examples arose:

| | | | | | | |
|---|---|---|---|---|---|---|
| AARON | _{—} | eh | r | ax | n | |
| AARONS | ey | _{—} | r | ih | n | z |

Notice that the first “A” in “AARON” is aligned to “_,” and the second letter “A” in word “AARONS” is aligned to “_.” During the DTPM training process, the epsilon phone “_” may not have enough counts to force either the first “A” or the second “A” in “AARON” to provide an epsilon phone. The problem arises in such a situation. To address the problem, a position-dependent rearrangement process may be inserted into the above TTP method after step 3(c), i.e., if one of the aligned phonemes of two identical letters is an epsilon phone, the rearrangement process swaps the aligned phonemes as required to force the second output phoneme to be the epsilon phone. Table 1 sets forth exemplary pseudo-code for the rearrangement process.

For each letter index i in word W

j=i + 1
if l[i]=l[j] && p[i]==_ && p[j]!=_{—}

then

SWAP(p[i], p[j])

fi

done

Table 1—Exemplary Pseudo-Code for the Rearrangement Process where l[i] and p[i] are the letter and phone at position i in an aligned TTP pair, respectively.

Since the estimated \tilde{P}(p|l) incorporates subjective prior probabilities, examining where large discrepancies in P(p|l)=C(l, p)/C(l) exist may reveal the following information.

Misspelled words: These words have small counts, and therefore a large discrepancy between \tilde{P}(p|l) and P(p|l) may be observed.

Abbreviations: Abbreviations usually require pseudo-phonemes. The number of abbreviations are not large, and therefore a large discrepancy between \tilde{P}(p|l) and P(p|l) may be observed.

Misspelled words and some abbreviations that are not useful for training pronunciation models from the training dictionary may be removed to avoid these potential discrepancies. In such a way, human knowledge on dictionary alignment can also be improved.

The mapping from spelling to the corresponding phoneme may be carried out using a decision-tree based pronunciation model (see, e.g., Quinlan, C4.5: Programs for Machine Learning, Morgan Kaufmann Publishers, 1992). One embodiment of a DTPM based on the TTP technique will now be described. The following conditions hold for the specific embodiment herein described. A single pronunciation is generated for each name. The decision trees are trained on the aligned pronunciation dictionary. A single tree is trained for each letter. A decision tree consists of nodes that are internal with questions of context and leaves with output phonemes. Training cases of decision trees are composed of left- and right-letters of the current letter and left phoneme classes (such as vowels and consonants). A training case for the current letter consists of four left letters, four right letters to the current letter, four phoneme classes of the four left letters, and the corresponding phoneme of the current letter.

In the described embodiment, training is performed in two phases. The first phase splits nodes into child nodes according to an information-theoretic optimization criterion (see, e.g., Quinlan, supra). The splitting continues until the optimization criterion cannot further be improved. The second phase prunes the decision trees by removing those nodes from the tree that do not contribute to the modeling accuracy. Pruning is desirable to avoid over-training and maintains certain generalization ability. Pruning also reduces the size of the trees, and therefore may be preferred for mobile telecommunication devices in which memory constraints are material. A reduced-error pruning (see, e.g., Quinlan, supra) is used for the second phase. Such reduced-error pruning will be called “DTPM-pruning” herein.

The phoneme sequence of a word is generated by applying decision tree of each letter from left to right. First, the decision tree corresponding to the letter in question is selected. Then, questions in the tree are answered until a leaf is located. The phoneme stored in the leaf is then selected as the pronunciation of the letter. The process moves to the next letter. The phoneme sequence is constructed by concatenating the phonemes that have been found for the letters of the word. Pseudo-phonemes are split, and epsilon phones are removed from the final phoneme sequence.

Having described a DTPM based on the TTP technique, the performance of an exemplary embodiment of the TTP technique of the present invention will be evaluated in the context of SIND in a mobile telecommunication device.

TTP mappings are trained on a so-called “pronunciation dictionary.” The acoustic models in experiments were trained from the well-known Wall Street Journal (WSJ) database. The well-known CALLHOME American English Lexicon (PRONLEX) (see, LDC, “CALLHOME American English Lexicon,” http://www.ldc.upenn.edu/) was also used. Since the task is name recognition, letters such as “.” and “'” were removed from the dictionary. Some English names were also added into the dictionary. The resulting dictionary had 96,500 entries with multiple pronunciations. A DTPM was then trained after TTP alignment of the pronunciation dictionary.

The name database, called WAVES, was collected in a vehicle, using an AKG M2 hands-free distant talking microphone, in three recording conditions: parked (car parked, engine off), city driving (car driven on a stop-and-go basis) and highway driving (car driven at a relatively constant speed on a highway). In each condition, 20 speakers (ten of which being male) uttered English names. The WAVES database contained 1325 English name utterances collected in cars.

The WAVES database was sampled at 8 kHz, with frame rate of 20 ms. From the speech, 10-dimensional MFCC features and their delta coefficients were extracted. Because it was recorded using hands-free microphones, the WAVES database presented several severe mismatches.

The microphone is distant-talking band-limited, as compared to a high-quality microphone used to collect the WSJ database.

A substantial amount of background noise is present due to the car environment, with SNR decreasing to 0 dB in highway driving.

Pronunciation variations of names exist, not only because different people often pronounce the same name in different ways, but also as a result of the data-driven pronunciation model.

Although not necessary to an understanding of the performance of the technique of the present invention, the experiment also involved a novel technique introduced in (application Ser. No. [Attorney Docket No. TI-39862P1], supra) and called “IJAC” to compensate for environmental effects on acoustic models.

Experiment 1: TTP as a Function of the Inner-Loop Iteration Number n

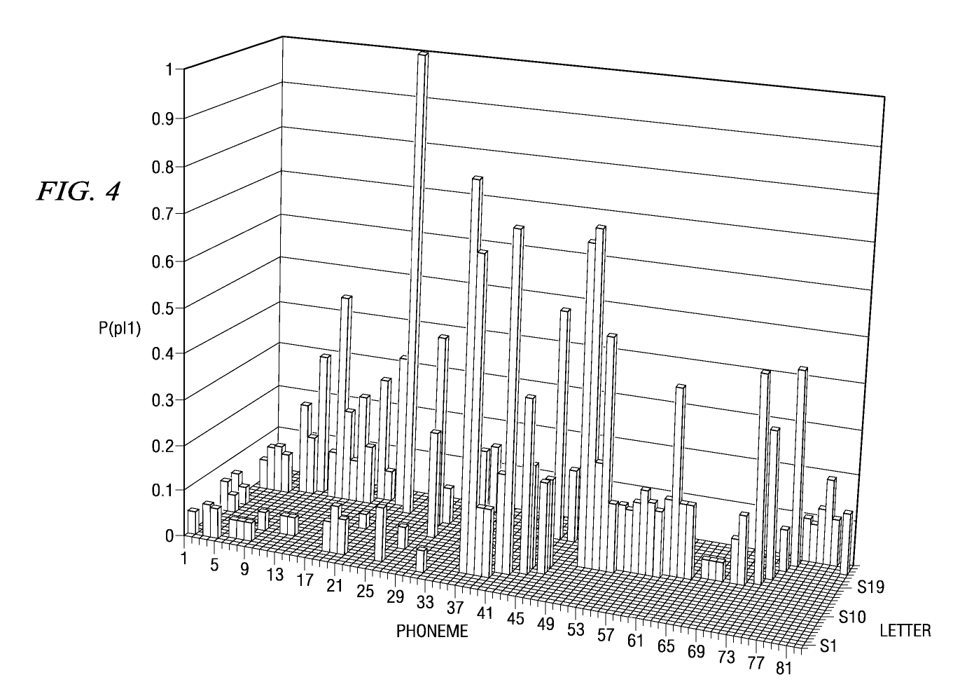

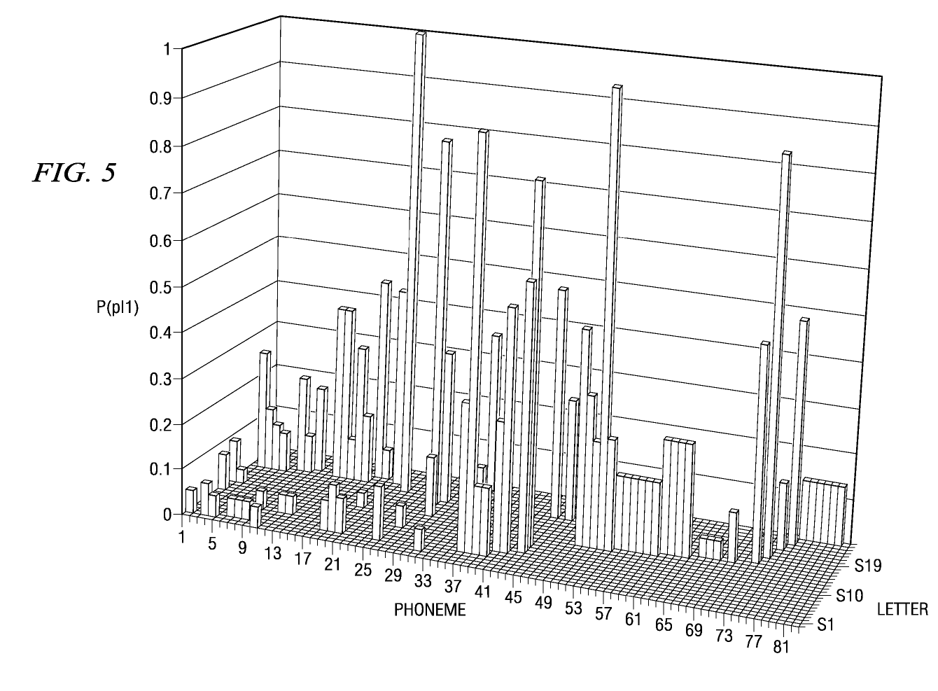

FIGS. 4 and 5 show the estimated posterior probability of a particular phoneme given a particular letter P(p|l) (θ_{A}=0.003). FIG. 5 with n=5 is more ordered than FIG. 4 with n=1 at initialization. Encouragingly, the strongest peaks at convergence n=5 are also among the strongest peaks at n=1. This indicates that the naive initialization provides an effective starting point for the technique of the present invention.

At convergence, some posterior probabilities become zero, for example, the posterior probability of “w_ah” given the letter “A.” This observation suggests that the TTP technique properly regularizes training cases for DTPM by removing some LTP mappings with low posterior probability.

Entropy may be used to measure the irregularity of LTP mapping. The entropy is defined as

$$P ( p \vert l ) log \frac{1}{P ( p \vert l )} .$$

Averaging over all LTP pairs, the averaged entropy at initialization was determined to be 0.78. After five iterations, the averaged entropy decreased to 0.57. This quantitative result showed that the TTP technique was able to regularize LTP mappings.

Experiment 2: TTP as a Function of the Outer-Loop Iteration Number r

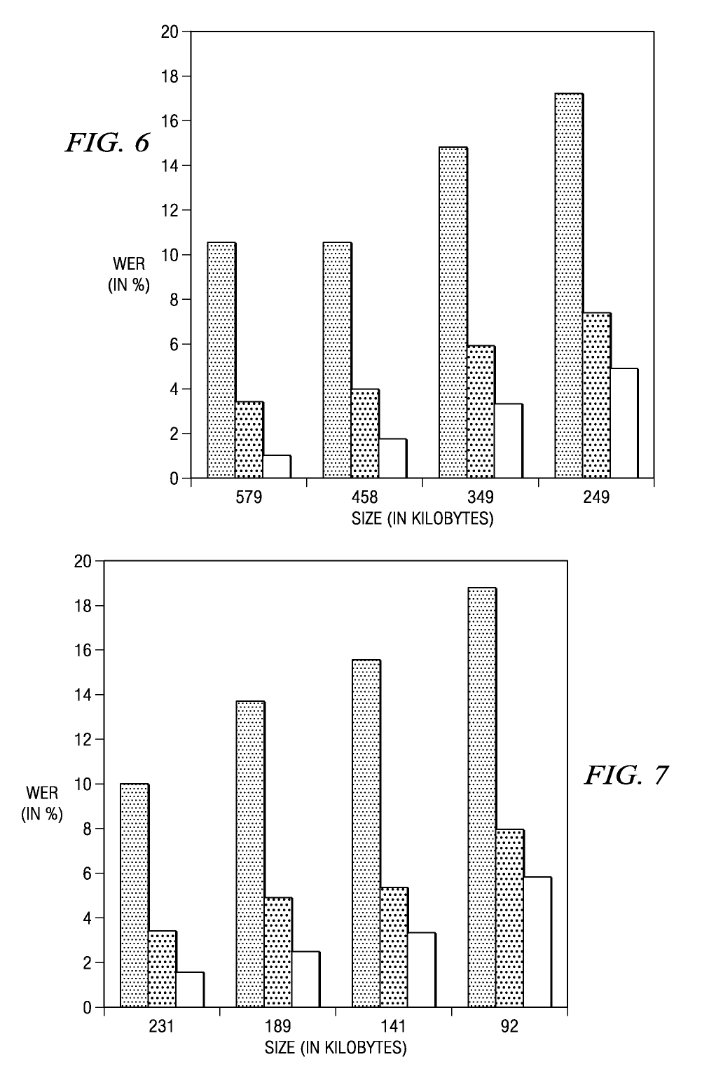

FIG. 6 shows word error rates in different driving conditions as a function of memory size of un-pruned DTPMs (un-pruned DTPMs were trained without the DTPM-pruning process described above). (θ_{A}=0.003). The memory size was smaller with when the outer-loop iteration number r was increased.

Table 2 shows LTP mapping accuracy as a function of the iteration r for the un-pruned DTPMs.

TABLE 2
LTP Alignment Accuracy as a Function of Outer-Loop Iteration r

| | Iteration Number r | | | |
|---|---|---|---|---|
| | 1 | 2 | 3 | 4 |
| LTP accuracy (in %) | 91.42 | 88.16 | 83.16 | 79.04 |
| Memory size (Kbytes) | 579 | 458 | 349 | 249 |

Table 2 shows that, although the size of DTPMs was smaller with increased outer-loop iteration, LTP accuracy was lower, and recognition performance degraded. A similar trend can be observed for a pruned-DTPM that uses the DTPM-pruning process described above. This trend result from the fact that, at each iteration r, the LTP-pruning process may remove some LTP mappings with a lower posterior probability than the threshold θ_{A}. As the size of the training data decreases, the reliability of DTPM estimation decreases.

It is interesting to compare performance as a function of DTPM-pruning. FIG. 7 shows that a pruned DTPM attained a word error ratio (WER) of 1.67% with a 231 Kbyte memory size in a parked condition. In contrast, FIG. 6 shows that an un-pruned DTPM after four iterations attained a WER of 4.91% with a memory size of 249 Kbytes in a parked condition. Although they had a similar memory size, the pruned DTPM performed substantially better than the un-pruned DTPM. Together with results in other conditions, it is apparent that the DTPM-pruning process is able to attain DTPMs with better performance than those without the pruning, given comparable memory sizes.

Given these observations, the pruned DTPMs with r=1 were selected for the experiments that will now be described.

Acoustic models were trained from the WSJ database. The acoustic models were intra-word, context-dependent, triphone models. The models were gender-dependent and had 9573 mean vectors. Mean vectors were tied by a generalized tied-mixture (GTM) process (see, U.S. patent application Ser. No. [Attorney Docket No. TI-39685], supra).

Two types of hidden Markov models (HMMs) were used in the following experiments. One HMM was a generalized tied-mixture HMM with an analysis of pronunciation variation, denoted Analysis of pronunciation variation was done by Viterbi-aligning multiple pronunciations of words (yielding statistics for substitution, insertion and deletion errors), tying those mean vectors that belonged to the models that generated the errors and then performing E-M trainings. Pronunciation variation was analyzed using the WSJ dictionary. The other HMM was a generalized tied-mixture HMM without analysis of pronunciation variation, denoted “HMM-2.” A mixture was tied to other mixtures with the smallest distances from it. Although the total number of mean vectors was not increased, average mean vectors per state increased from one to ten in these two types of HMMs.

Experiment 3: Performance as a Function of Probability Threshold θ_{A}

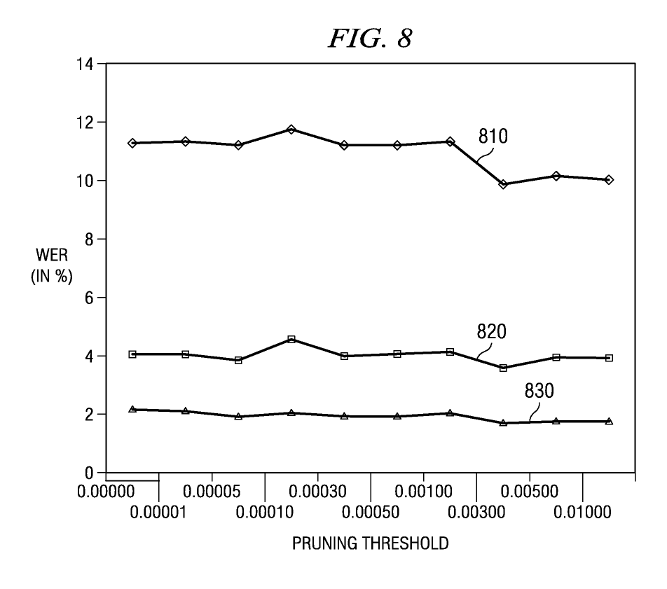

A parameter, probability threshold θ_{A}, is used for LTP-pruning those LTP with low a posteriori probability P(p|l). The larger the threshold θ_{A}, the fewer the number of LTP mappings are allowed. This section presents results with a set of θ_{A} using HMM-1. Experimental results are shown in Table 3, below, together with a plot of the recognition results in FIG. 8. In FIG. 8, the line 810 represents the highway driving condition; the line 820 represents the city driving condition; and the line 830 represents the parked condition.

TABLE 3
WER of WAVES Name Recognition
Achieved by Un-Pruned DTPM

| | θ_{A} | | | | |
|---|---|---|---|---|---|
| | 0.0000 | 0.00001 | 0.00005 | 0.0001 | 0.0003 |
| Highway | 11.28 | 11.36 | 11.19 | 11.77 | 11.23 |
| driving | | | | | |
| City | 4.04 | 4.04 | 3.83 | 4.54 | 3.96 |
| driving | | | | | |
| Parked | 2.16 | 2.08 | 1.95 | 2.04 | 1.99 |
| Size | 244 | 244 | 244 | 244 | 243 |
| (Kbytes) | | | | | |
| LTP Acc | 83.73 | 88.73 | 88.76 | 88.67 | 88.67 |
| (in %) | | | | | |
| | θ_{A} | | | | |
| | 0.0005 | 0.001 | 0.003 | 0.005 | 0.01 |
| Highway | 11.23 | 11.32 | 9.90 | 10.14 | 10.04 |
| driving | | | | | |
| City | 4.04 | 4.13 | 3.56 | 3.90 | 3.94 |
| driving | | | | | |
| Parked | 1.99 | 2.04 | 1.67 | 1.75 | 1.75 |
| Size | 243 | 239 | 231 | 229 | 221 |
| (Kbytes) | | | | | |
| LTP Acc | 88.64 | 88.51 | 88.60 | 88.57 | 88.41 |
| (in %) | | | | | |

Referring to Table 3, the size of the DTPM was decreased by increasing θ_{A}. Without the threshold (i.e., θ_{A}=0.0), LTP accuracy was 83.73%. By removing some unreliable LTP mapping with a non-zero θ_{A} (θ_{A}=0.00001), LTP accuracy increased to 88.73%. However, after a certain value of θ_{A}, e.g., θ_{A}=0.005, LTP accuracy decreased.

A certain range of θ_{A} exists in which the trained DTPM attains a lower WER. Compared to the WER with θ_{A}ε[0, 0.001], the WER with θ_{A}ε[0.003, 0.01] was lower. In the specific experiment set forth, setting θ_{A}=0.003 results in the lowest WER in three driving conditions.

Experiment 4: Performance with Better Prior Knowledge of LTP Mapping

Experiments (using HMM-1) were then conducted with a view to improving the prior probability of a particular phoneme given a particular letter. In particular, some LTP mapping with a Spanish origin, such as (J, y) and (J, hh), were removed by setting their prior probabilities to zero. Table 4 shows results by the modified prior probabilities.

TABLE 4
WER of WAVES Name Recognition Achieved by Pruned DTPM

| | θ_{A} | | | | |
|---|---|---|---|---|---|
| | 0.0000 | 0.00001 | 0.00005 | 0.0001 | 0.0003 |
| Highway | 11.19 | 11.19 | 11.03 | 11.07 | 11.07 |
| City | 4.02 | 4.02 | 3.81 | 3.94 | 3.94 |
| driving | | | | | |
| Parked | 2.04 | 2.04 | 1.91 | 1.95 | 1.95 |
| Size | 243 | 243 | 243 | 243 | 243 |
| (Kbytes) | | | | | |
| LTP Acc | 88.76 | 88.76 | 88.79 | 88.70 | 88.70 |
| (in %) | | | | | |
| | θ_{A} | | | | |
| | 0.0005 | 0.001 | 0.003 | 0.005 | 0.01 |
| Highway | 11.07 | 11.15 | 9.90 | 10.14 | 10.04 |
| City | 4.02 | 4.11 | 3.56 | 3.90 | 3.94 |
| driving | | | | | |
| Parked | 1.95 | 1.99 | 1.67 | 1.75 | 1.75 |
| Size | 242 | 239 | 231 | 229 | 221 |
| (Kbytes) | | | | | |
| LTP Acc | 88.67 | 88.54 | 88.60 | 88.57 | 88.41 |
| (in %) | | | | | |

Compared to the results in Table 3, the following observations are made:

Better prior knowledge of LTP is helpful in having smaller DTPM with better performance. In particular, removal of some Spanish pronunciation in prior probabilities improves performance of DTPM. For instance, compared to results in Table 2 with θ_{A}=0.0, the size of the DTPM was decreased from 244 Kbytes to 243 Kbytes, LTP accuracy was increased from 83.73% to 88.76%, and WER in all three driving conditions was decreased in average by 2.3%.

Above a certain value of θ_{A}, the prior probability may not have much effect on performance of the DTPM. In the experiment, better prior knowledge had effects on performances with θ_{A}ε[0, 0.001], but did not result in improved performance for a larger θ_{A}. The observation may be due to less Spanish pronunciation in the training dictionary. This suggests that the proposed TTP technique does not rely much on human effort.

Experiment 5—Performance by Position-Dependent Rearrangement and a Set of Acoustic Models

TABLE 5
LTP Accuracy and memory size of pruned DTPM
with different probability thresholds

| | θ_{A} | | | | |
|---|---|---|---|---|---|
| | 0.0 | 0.001 | 0.002 | 0.003 | 0.005 |
| Size | 233 | 226 | 224 | 224 | 223 |
| (Kbytes) | | | | | |
| LTP Acc | 88.70 | 88.57 | 88.64 | 88.70 | 88.73 |
| (in %) | | | | | |

Now, TTP performance with a position-dependent rearrangement process as described above will be analyzed. Table 5 shows LTP accuracy and memory size of trained DTPMs as a function of various thresholds θ_{A}. By comparison with Table 4, the following observations are made:

Given the same θ₄, the size of the trained DTPMs with the rearrangement process is smaller than the trained DTPMs without the rearrangement process. For example, with θ_{A}=0.003, the new DTPM is 224 Kbytes, whereas the DTPM in Table 4 is 231 KBytes.

LTP accuracies are comparable. This observation suggests that the newly-added position-dependent rearrangement process achieves similar LTP performance with smaller memory. Therefore, the new process is useful for TTP.

Based on the newly aligned dictionary with the position-dependent rearrangement process, recognition experiments were performed with both HMM-1 and HMM-2 acoustic models. Tables 6 and 7 show the results with HMM-1 and HMM-2, respectively.

TABLE 6
WER of WAVES name recognition achieved by
pruned DTPM Using Acoustic Model HHM-1

| | θ_{A} | | | | |
|---|---|---|---|---|---|
| | 0.0 | 0.001 | 0.002 | 0.003 | 0.005 |
| Highway | 11.65 | 11.79 | 10.16 | 10.02 | 10.06 |
| City | 4.70 | 4.53 | 3.94 | 3.85 | 3.81 |
| driving | | | | | |
| Parked | 2.30 | 2.50 | 1.89 | 1.81 | 1.97 |

TABLE 7
WER of WAVES name recognition achieved by
pruned DTPM Using Acoustic Model HHM-2

| | θ_{A} | | | | |
|---|---|---|---|---|---|
| | 0.0 | 0.001 | 0.002 | 0.003 | 0.005 |
| Highway | 11.89 | 12.08 | 9.67 | 9.51 | 9.59 |
| City | 5.46 | 5.30 | 3.68 | 3.71 | 3.75 |
| driving | | | | | |
| Parked | 2.69 | 2.85 | 1.75 | 1.67 | 1.87 |

The following observations are made:

As observed in the previous recognition experiments, the recognition performances of the trained DTPMs are dependent on the threshold θ_{A}. For example, in the city driving condition in Table 6, the WER with θ_{A}=0.003 outperformed the WER with θ_{A}=0.001 by 15%. In Table 6, the WERs with θ_{A}=0.003 were 2% lower on average than WERs with θ_{A}=0.002.

Although HMM-1 outperformed HMM-2 with θ_{A}ε[0, 0.001], the performance of HMM-2 was better than HMM-1 in the case of θ_{A}ε[0.002, 0.005], the range in which both HMM-1 and HMM2 achieved their lowest WERs. For instance, with θ_{A}=0.003, HMM-2 outperformed HMM-1 in all three driving conditions by 5%.

Considering both memory size and recognition performance, DTPM performance using HMM-2 and with θ_{A}=0.003 yielded the best performance.

To achieve a good compromise between performance and complexity, it may be desirable to use a look-up table containing phonetic transcriptions of those names that are not correctly transcribed by the decision-tree-based TTP. The look-up table requires only a modest increase of storage space, and the combination of decision-tree-based TTP and look-up table may achieve high performance.

Although the present invention has been described in detail, those skilled in the pertinent art should understand that they can make various changes, substitutions and alterations herein without departing from the spirit and scope of the invention in its broadest form.

What is claimed is:

1. A system for text-to-phoneme mapping, comprising:
a letter-to-phoneme mapping generator configured to generate a letter-to-phoneme mapping by iteratively aligning a full training set with a set of correctly aligned entries based on statistics of phonemes and letters from said set of correctly aligned entries and redefining said full training set as a union of said set of correctly aligned entries and a set of incorrectly aligned entries created during said aligning; and
a model trainer configured to update prior probabilities of letter-to-phoneme mappings generated by said letter-to-phoneme generator and evaluate whether said letter-to-phoneme mappings are suitable for training a decision-tree-based pronunciation model.

2. The system as recited in claim 1 wherein said letter-to-phoneme mapping generator is configured to employ an E-M-type algorithm iteratively to align said full training set with said set of correctly aligned entries.

3. The system as recited in claim 1 wherein said letter-to-phoneme mapping generator is configured to obtain said statistics by calculating a probability of a particular phoneme given a particular letter, calculating a probability of said particular letter given said particular phoneme and updating a posterior probability of said particular phoneme given said particular letter.

4. The system as recited in claim 1 wherein said letter-to-phoneme mapping generator is configured iteratively to align said full training set with said set of correctly aligned entries by text-to-phoneme aligning every entry in said training set to obtain a phoneme sequence having a maximum a posteriori probability and checking if every letter-phoneme pair in said every entry is allowed.

5. The system as recited in claim 1 wherein said model trainer is configured to evaluate whether said letter-to-phoneme mappings are suitable for training said decision-tree-based pronunciation model by pruning said letter-to-phoneme mappings generated by said letter-to-phoneme generator and comparing posterior probabilities in said letter-to-phoneme mappings to a threshold.

6. The system as recited in claim 1 wherein said letter-to-phoneme mapping generator is configured to generate said letter-to-phoneme mapping over a predetermined number of iterations and said model trainer is configured to evaluate a predetermined number of said letter-to-phoneme mappings.

7. The system as recited in claim 1 wherein said system is embodied in a digital signal processor.

8. A method of text-to-phoneme mapping, comprising:
generating a letter-to-phoneme mapping by iteratively aligning a full training set with a set of correctly aligned entries based on statistics of phonemes and letters from said set of correctly aligned entries and redefining said full training set as a union of said set of correctly aligned entries and a set of incorrectly aligned entries created during said aligning;
updating prior probabilities of letter-to-phoneme mappings generated by said letter-to-phoneme generator; and
evaluating whether said letter-to-phoneme mappings are suitable for training a decision-tree-based pronunciation model.

9. The method as recited in claim 8 wherein said generating comprises employing an E-M-type algorithm iteratively to align said full training set with said set of correctly aligned entries.

10. The method as recited in claim 8 wherein generating comprises obtaining said statistics by calculating a probability of a particular phoneme given a particular letter, calculating a probability of said particular letter given said particular phoneme and updating a posterior probability of said particular phoneme given said particular letter.

11. The method as recited in claim 8 wherein said aligning comprises aligning every entry in said training set to obtain a phoneme sequence having a maximum a posteriori probability and checking if every letter-phoneme pair in said every entry is allowed.

12. The method as recited in claim 8 wherein said evaluating comprises pruning said letter-to-phoneme mappings generated by said letter-to-phoneme generator and comparing posterior probabilities in said letter-to-phoneme mappings to a threshold.

13. The method as recited in claim 8 wherein said generating is carried out over a predetermined number of iterations and said evaluating is carried out on a predetermined number of said letter-to-phoneme mappings.

14. The method as recited in claim 8 wherein said method is carried out in a digital signal processor.

15. A digital signal processor, comprising:
data processing and storage circuitry controlled by a sequence of executable instructions configured to:
generate a letter-to-phoneme mapping by iteratively aligning a full training set with a set of correctly aligned entries based on statistics of phonemes and letters from said set of correctly aligned entries and redefining said full training set as a union of said set of correctly aligned entries and a set of incorrectly aligned entries created during said aligning;
update prior probabilities of letter-to-phoneme mappings generated by said letter-to-phoneme generator; and
evaluate whether said letter-to-phoneme mappings are suitable for training a decision-tree-based pronunciation model.

16. The digital signal processor as recited in claim 15 wherein said sequence of executable instructions is further configured to employ an E-M-type algorithm iteratively to align said full training set with said set of correctly aligned entries.

17. The digital signal processor as recited in claim 15 wherein said sequence of executable instructions is further configured to obtain said statistics by calculating a probability of a particular phoneme given a particular letter, calculating a probability of said particular letter given said particular phoneme and updating a posterior probability of said particular phoneme given said particular letter.

18. The digital signal processor as recited in claim 15 wherein said sequence of executable instructions is further configured to align every entry in said training set to obtain a phoneme sequence having a maximum a posteriori probability and check if every letter-phoneme pair in said every entry is allowed.

19. The digital signal processor as recited in claim 15 wherein said sequence of executable instructions is further configured to prune said letter-to-phoneme mappings generated by said letter-to-phoneme generator and compare posterior probabilities in said letter-to-phoneme mappings to a threshold.

20. The digital signal processor as recited in claim 15 wherein said sequence of executable instructions is further configured to generate said letter-to-phoneme mapping over a predetermined number of iterations and evaluate a predetermined number of said letter-to-phoneme mappings.
